(19) United States
(12) Patent Application Publication
(10) Pub. No.: US 2014/0188570 A1
(43) Pub. Date: Jul. 3, 2014

(54) Method of Promoting an Illuminated Outdoor Decoration

(71) Applicant: Shari K. Sanford, Pinehurst, NC (US)

(72) Inventor: Shari K. Sanford, Pinehurst, NC (US)

(21) Appl. No.: 14/145,687

(22) Filed: Dec. 31, 2013

Related U.S. Application Data
(60) Provisional application No. 61/748,442, filed on Jan. 2, 2013.

(51) Int. Cl. G06Q 30/02; G06Q 10/06

(52) U.S. Cl. CPC G06Q 30/0241; G06Q 10/0637
USPC 705/7.36

(57) ABSTRACT

A series of business methods, processes, and results is disclosed. The methods license popular and readily identified sports-related trademarks and copyrighted images and use these trademarks and copyrighted images in the production of illuminated decorations. A device that will preferably provide a transparent or translucent three dimensional image of a popularly identifiable figure, such as a sports mascot or emblem, or a player in a sports uniform is provided. The popularly identifiable figure would be a trademark or copyrighted image from a popular sports team, and the trademark or copyrighted image would be licensed for production as part of a licensing agreement. Preferably, the sports team or university would enjoy advertisement for their organization any time the device was displayed. A light source affixed inside or behind the device will make it appear to glow.

### CROSS-REFERENCE TO RELATED APPLICATIONS

This application claims priority to U.S. Provisional Application No. 61/748,442 filed Jan. 2, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to illuminated decorations and in particular to transparent or translucent decorations illuminated from the inside whose appeal and marketability are enhanced by emulating widely recognized sports logos and mascots. Sports enthusiasts are eager to show their support for their favorite sports, and in particular their favorite teams, by decorating portions of their indoor and outdoor living spaces with sporting related paraphernalia. Making transparent or translucent, three dimensional decorations illuminated from the inside or behind, in the forms of popularly identifiable figures, such as favorite sports mascots and emblems, players in sports uniforms and other symbols, would help to fulfill the demand by sports enthusiasts.

### SUMMARY OF THE INVENTION

Accordingly, the invention is directed to a series of business methods, processes, and results that license popular and readily identified sports-related trademarks and copyrighted images, and use these trademarks and copyrighted images in the production of illuminated decorations. The method of the invention incorporates a device that will preferably incorporate a transparent or translucent three dimensional image of a popularly identifiable figure, such as a sports mascot or emblem, or a player in a sports uniform. The popularly identifiable figure would be a trademark or copyrighted image from a popular sports team, and the trademark or copyrighted image would be licensed for production as part of a licensing agreement. Preferably, the sports team or university would enjoy advertisement for their organization any time the device was displayed. Any basically rigid, durable material can comprise the basic components of the device, preferably, blow molded plastic. A light source affixed inside or behind the device will make it appear to glow.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

No drawing is provided for the disclosed invention because a drawing is not necessary for the understanding of the invention under 35 U.S.C. §113, 37 §1.81(a), and MPEP §608.02 (III) (A).

### DETAILED DESCRIPTION OF THE INVENTION

Referring now to the invention in more detail, the invention is directed to a series of business methods, processes, and results that license popular and readily identified sports-related trademarks and copyrighted images, and use these trademarks and copyrighted images in the production of illuminated decorations. The method of the invention incorporates a device that will preferably provide a transparent or translucent, three dimensional image of a popularly identifiable trademarked or copyrighted figure, such as a sports mascot or a player in a sports uniform, forming the body. The device would preferably be manufactured of rigid, durable material, such as, blow molded plastic. A light source affixed inside or behind the device, powered by a either an external power source such as a power cord, or by an internal power source such as, batteries, will illuminate it, making it appear to glow.

Various mascots and sports figures, in different team colors, would preferably be manufactured and marketed to sports enthusiasts in different geographic regions. The device would preferably incorporate mascots and popularly identifiable figures, images, emblems, and slogans from all levels of sports, from amateur to professional. Rights to the material covered by registered or common law trademark protection or by copyright protection, right of publicity, trade secret, geographic designation, patent or other form of intellectual property would be obtained by licensing, purchasing, obtaining control of, or otherwise obtaining use rights in the material and paying royalties to the applicable rights holder(s), which most commonly will be professional sports franchises and professional sports leagues as well as universities, secondary schools, and academic athletic associations such as the National Collegiate Athletic Association (NCAA). Such licenses and royalties would be negotiated between the applicable rights holder(s) and a manufacturer, marketer, distributor, promoter, designer or other entity practicing the invention.

Each entity represented by the device would enjoy advertisement in places it normally would not traditionally promote itself. Because these particular devices are popular to display in high visibility areas of a residence or business such as lawns, driveways, doorways, porches, or in windows, as well as on vehicle dashboards. Each entity could reach large numbers of sports enthusiasts that it normally would not reach. Unlike holiday related illuminated decorations that have limited periods for display, this device could be displayed all year and would have no specific time period limiting its display. The devices could be marketed to specific sports fans, followers, or enthusiasts through websites, television, radio, print periodicals, and mail order, in department and specialty stores, and at stadiums, baseball parks, basketball arenas and other sporting venues. In particular, fans, followers, and enthusiasts may be reached via regional campaigns focusing on localized or in-person media throughout a particular region where a particular sports team or franchises enjoys a popular following.

Business methods and practices listed above are preferable, but artisans will recognize that different business methods and practices could be employed without altering the scope of the invention. In particular, the method of the invention need not be limited to sports-related images, slogans, figures, mascots, etc., but may also be applied to content drawn from other areas of popular culture such as film, television, music, fiction, video games, comics, and toys.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A business plan, system and method for manufacturing, marketing, selling, and distributing transparent or translucent three-dimensional decorations, comprising:
(a) initiating a series of licensing transactions between a user and at least one rights holder;
(b) said user being any of the group of a manufacturer, marketer, distributor, promoter, or designer of goods;
(c) said at least one rights holder owning or controlling at least one intellectual property right to at least one mascot, popularly identifiable figure, emblem, image, or slogan;
(d) said series of transactions being of a nature whereby said user obtains a use right to manufacture themed decorations employing said at least one intellectual property right to at least one mascot, popularly identifiable figure, emblem, image, or slogan;
(e) said themed decoration comprising internally illuminated, translucent decorations;
(e) identifying fans, followers, or enthusiasts of said at least one mascot, popularly identifiable figure, emblem, image, or slogan; and
(c) marketing said themed decorations to said fans, followers or enthusiasts;
whereby the marketing of said themed decorations would influence said fans, followers, or enthusiasts to purchase, display, and use said themed decorations.

2. The business plan, system, and method of claim 1 wherein said at least one mascot, popularly identifiable figure, emblem, image, or slogan relates thematically to a sports team or franchise.

3. The business plan, system, and method of claim 2 wherein said themed decorations are designed to resemble mascots of a specific sports team, athletes wearing the uniforms of a specific sports team, or a combination thereof.

4. The business plan, system, and method of claim 1 wherein said user employs regional marketing media to market said themed decorations to said fans, followers, or enthusiasts.

5. The business plan, system, and method of claim 2 wherein said user employs regional marketing media to market said themed decorations to said fans, followers, or enthusiasts.

6. The business plan, system, and method of claim 5 wherein said user employs regionally targeted advertising to reach said fans, followers, or enthusiasts, said fans, followers, or enthusiasts being of a specific sports team, and said regional marketing media being directed to the region wherein said sports team is located.

7. The business plan, system, and method of claim 1 wherein said themed decorations are of designs which are properly sized for display in, on, or about the residences or businesses of said fans, followers, or enthusiasts.

8. The business plan, system, and method of claim 2 wherein said themed decorations are of designs which are properly sized for display in, on, or about the residences or businesses of said fans, followers, or enthusiasts.

9. The business plan, system, and method of claim 3 wherein said themed decorations are of designs which are properly sized for display in, on, or about the residences or businesses of said fans, followers, or enthusiasts.

10. The business plan, system, and method of claim 4 wherein said themed decorations are of designs which are properly sized for display in, on, or about the residences or businesses of said fans, followers, or enthusiasts.

11. The business plan, system, and method of claim 5 wherein said themed decorations are of designs which are properly sized for display in, on, or about the residences or businesses of said fans, followers, or enthusiasts.

12. The business plan, system, and method of claim 6 wherein said themed decorations are of designs which are properly sized for display in, on, or about the residences or businesses of said fans, followers, or enthusiasts.
